(19) United States
(12) Patent Application Publication
(10) Pub. No.: US 2018/0334104 A1
(43) Pub. Date: Nov. 22, 2018

(54) Rotating Vehicle Step

(71) Applicant: Ferdinand Rosario, Newmarket, NH (US)

(72) Inventor: Ferdinand Rosario, Newmarket, NH (US)

(21) Appl. No.: 15/983,271

(22) Filed: May 18, 2018

Related U.S. Application Data
(60) Provisional application No. 62/507,855, filed on May 18, 2017.

(51) Int. Cl. B60R 3/00; B60N 3/02; F16C 19/06

(52) U.S. Cl. CPC B60R 3/00; F16C 2326/01; F16C 19/06; B60N 3/02

(57) ABSTRACT

A rotatable step for a vehicle is provided. The rotatable step may be used for those entering and exiting a vehicle to allow pivoting from a direction facing towards or away from the vehicle, to a direction facing the front of the vehicle. The step may operate to prevent injury when a user is twisting their body to enter and exit a vehicle. The rotatable step can be built into the vehicle, or removably attachable thereto.

### BACKGROUND OF THE INVENTION

### Field of the Invention

The present invention relates generally to a step mounted on a vehicle to provide access to a vehicle cab. More particularly the present invention relates to a step which can swivel or rotate to prevent injury to a user entering or exiting a vehicle.

### Description of Related Art

When entering a vehicle, such as truck or tractor unit, often there are one or more steps leading up to the door to access the elevated cab. To get in and out of the cab, a user must pivot between facing forward in the driving position and facing towards or away from the vehicle, an approximately 90 degree pivot. This pivot motion, if not carefully executed, can put high stress on joints such as ankles, knees, hips, back, and the like. In some cases, serious injuries can occur from this entry/exit motion because while the hips swivel to get out of the vehicle, the foot remains in place, putting strain on knee and other joints.

Therefore, what is needed is a vehicle step that can allow a foot to pivot to provide a safe and comfortable way to enter and exit a vehicle.

### SUMMARY OF THE INVENTION

The subject matter of this application may involve, in some cases, interrelated products, alternative solutions to a particular problem, and/or a plurality of different uses of a single system or article.

In one aspect, a rotatable step for a vehicle is provided. The step is typically used in trucks, tractors, and other heavy duty vehicles which have cabs elevated from the ground to facilitate entry and exit from the cab. The rotatable step is formed of a base which is attachable or integratable into the vehicle, adjacent to a vehicle door. A rotatable platform is connected to a top of the base, on which a user may step, the rotatable platform can rotate, allowing a user standing on it to easily pivot directions. In a particular embodiment, the rotation of the platform relative to the body is limited by frictional forces to slow the rotation of the platform when a rotational force is applied.

In another aspect, a vehicle having an elevated door and a rotatable step is provided. The rotatable step is positioned adjacent to and below the door of the vehicle to allow a user to step out of the vehicle and onto the rotatable step. The rotatable step is formed of a base which is attached or integrated into the vehicle. A rotatable platform is connected to a top of the base, on which a user may step, the rotatable platform can rotate, allowing a user standing on it to easily pivot foot directions. In a particular embodiment, the rotation of the platform relative to the body is limited by frictional forces to slow the rotation of the platform when a rotational force is applied.

### BRIEF DESCRIPTION OF THE DRAWINGS

FIG. 1 provides an exploded view of an embodiment of the rotating vehicle step of the present invention.

FIG. 2 provides a perspective view of an embodiment of the rotating vehicle step of the present invention.

FIG. 3 provides an elevation view of an embodiment of the rotating vehicle step of the present invention.

FIG. 4 provides a view of an embodiment of the rotating vehicle step of the present invention installed on a vehicle.

FIG. 5 provides a bottom elevation view of an embodiment of the rotating vehicle step.

FIG. 6 provides a left side view of an embodiment of the rotating vehicle step.

FIG. 7 provides a right side view of an embodiment of the rotating vehicle step.

FIG. 8 provides a front view of an embodiment of the rotating vehicle step.

FIG. 9 provides a back side view of an embodiment of the rotating vehicle step.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

The present invention may be used to limit injury when entering or exiting a vehicle by using a platform that is attached to or used as a step to enter or exit a vehicle. The platform includes an elevated swiveling tread top, which can rotate 360 degrees. A user may step on the elevated swiveling top, and can pivot their foot as needed. The swiveling may be free swiveling, or may be movable against a specific resistance. In resistance embodiments, the swiveling tread top may be freely rotatable enough to prevent injury, but not so freely rotatable to cause a slipping or other hazard. Typically, a frictional resistance is what limits/slows the rotation of the platform relative to the base. While friction is always present, even in a freely spinning ball-bearing embodiment, additional friction may be intentionally created when assembling or adjusting the base-platform connection with the intention of slowing rotational movement. Other embodiments may be used without straying from the scope of the present invention, such as a tread top with limited range of rotation, and the like.

Generally, the present invention concerns a step that can rotate to allow pivoting when on the step. A base may form the step or may be connectable to the step. A rotating platform, such as a tread top is rotatably connected to the base to allow a swivel or rotation movement of the platform with respect to the base. Rotation may be achieved by any method. In many cases, the rotation may be against some resistance to prevent a free rotation/pivot, thereby limiting accidental slipping by a user. In embodiments connecting to an existing vehicle step, the body may define apertures through which a bolt or other connector may pass. In some cases, the apertures may be larger than the bolt passing through, allowing a variable positioning of the bolt.

In some embodiments, the rotation may be limited. For example, the rotation may be limited to 180 degrees at a time, 90 degrees, 45 degrees, 30 degrees, and the like. In further embodiments, the platform may be rotatable 360 degrees in limited increments, such as the increments noted above. The platform may need to be reset to allow further rotation, such as by removing a weight from the platform, to allow further motion.

A vehicle equipped with the step of the present invention may have just one rotating step on a driver's side, on both the passenger and drivers side, or multiple of the steps on each side. In many embodiments, even those having multiple steps up to the cap, there will typically be one swiveling step at the top step adjacent to the door and cab, because this is when the most body twisting occurs. Further, a handle may be positioned adjacent to the door and rotating step, to allow a user to hold onto the handle, place a foot on the step, and rotate safely into the cab.

In many embodiments, the top platform on which a user may step is formed as a disc having a circular cross section on the top. In other embodiments, differently shaped top platforms may be used, without straying from the scope of this invention.

The step may be positioned in various places adjacent to the door of the vehicle. In a particular embodiment, the step may be placed in a centered position under the door where a user may normally step. In another embodiment, the step may be placed forward of the door so that it is not accidentally stepped on for a user not intending to pivot on the rotatable step. A forwardly positioned step may also provide a favorable body positioning for a user to pivot on, especially in conjunction with the handle.

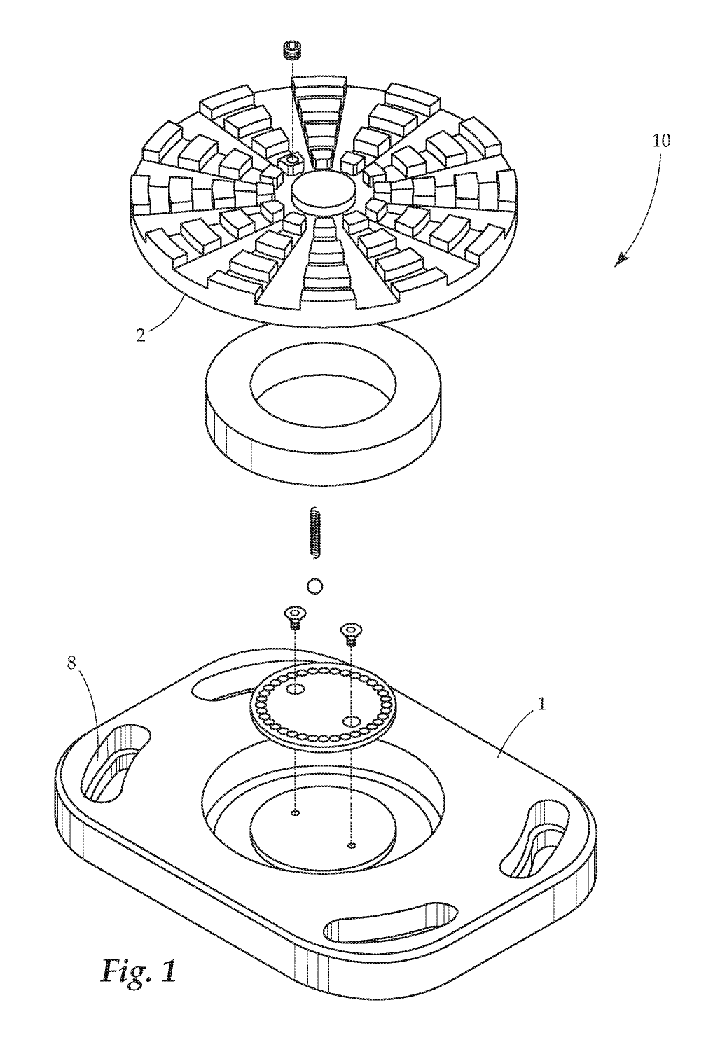

Turning now to FIG. 1 an exploded view of an embodiment of the rotating vehicle step is shown. The base 1 has four apertures 9 which allow connection to the vehicle or existing vehicle step. In other embodiments, (not shown) the base may be integrally formed into the vehicle body. The base has a depression 11 which houses rotational components of the rotating step by a connector passing through. In this embodiment, a ball plate 5 is connected to the base by two screws 8. A plurality of balls 4 fit into a plurality of depressions or a channel on the ball plate. A bearing 3 sits on the balls and is thereby rotatable. Compression spring 6 applies a desired amount of pressure between the base 1 and rotatable platform 2 to control a force required to rotate the rotatable platform, shown here as a tread top 2. In a particular embodiment, the compression spring 6 may be engaged with the ball bearing assembly 3, 4, 5, compressing it as needed. The tread top 2 is connected to the bearing 3. A set screw 7 passes through the tread top 2, with a head of the set screw 7 being accessible from the tread top. Upon tightening or loosening rotation of the set screw 7, a pressure on the compression spring 6 is adjusted, which in turn adjusts an amount of rotational resistance (the force required to rotate) on the tread top 2.

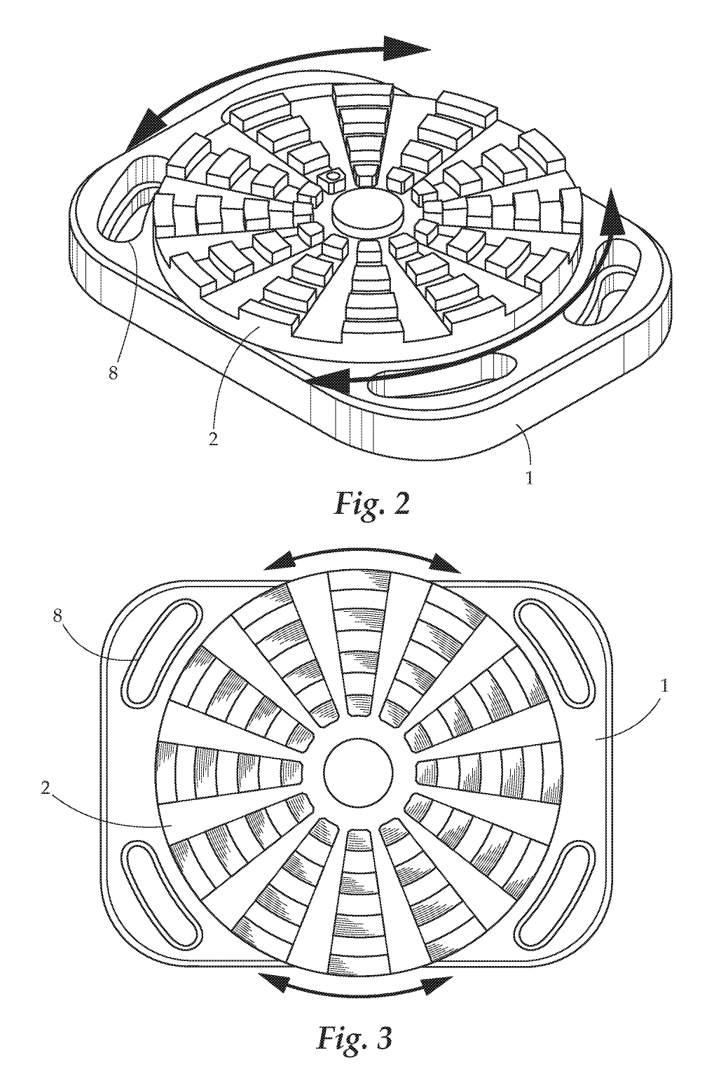

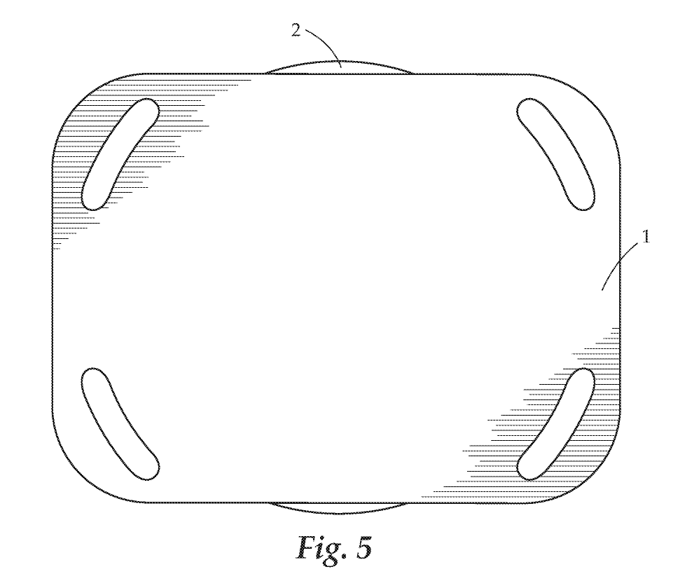

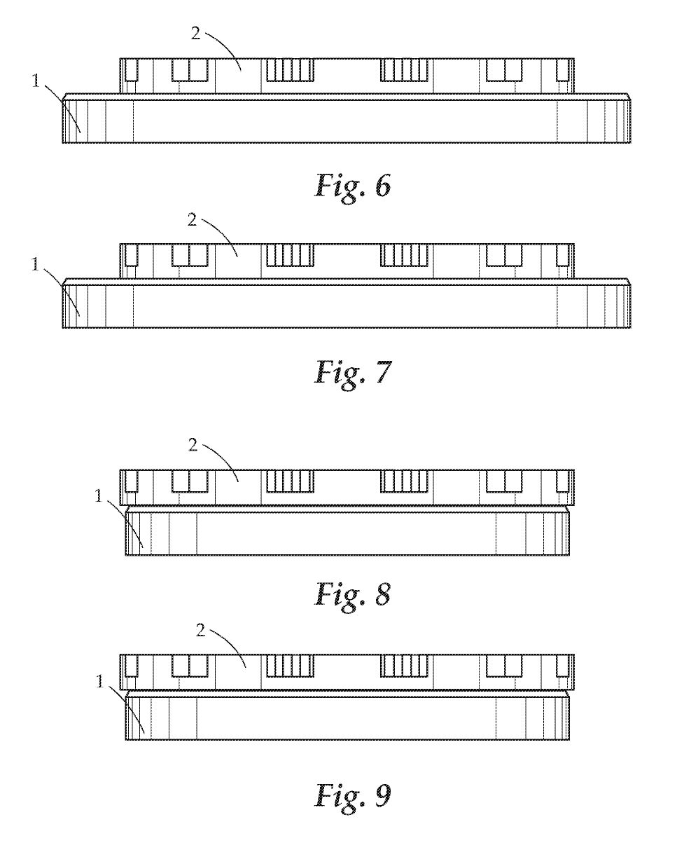

FIGS. 2, 3 and 5-9 show various views of another embodiment of the rotatable step. In this view, the rotatable tread top 2 has a plurality of radial grooves, and a plurality of concentric circumferential grooves. These combine to provide a gripping surface with makes slipping of a foot placed on the tread top 2 very unlikely. The tread top 2 is spaced slightly apart from the top of the base 1 to allow its rotation. The apertures 9 are shown as curving oval shaped apertures to allow a bolt or similar connector to fit through at various positions. The bolts (not shown) may engage with a grid or spacing of the step that is present in many steps, such as an expanded metal step. Given the variability in openings in the step material, the flexibility of positioning allowed by the curved oval shaped apertures provides much flexibility in attachment and attachment positioning of the step to existing vehicle steps.

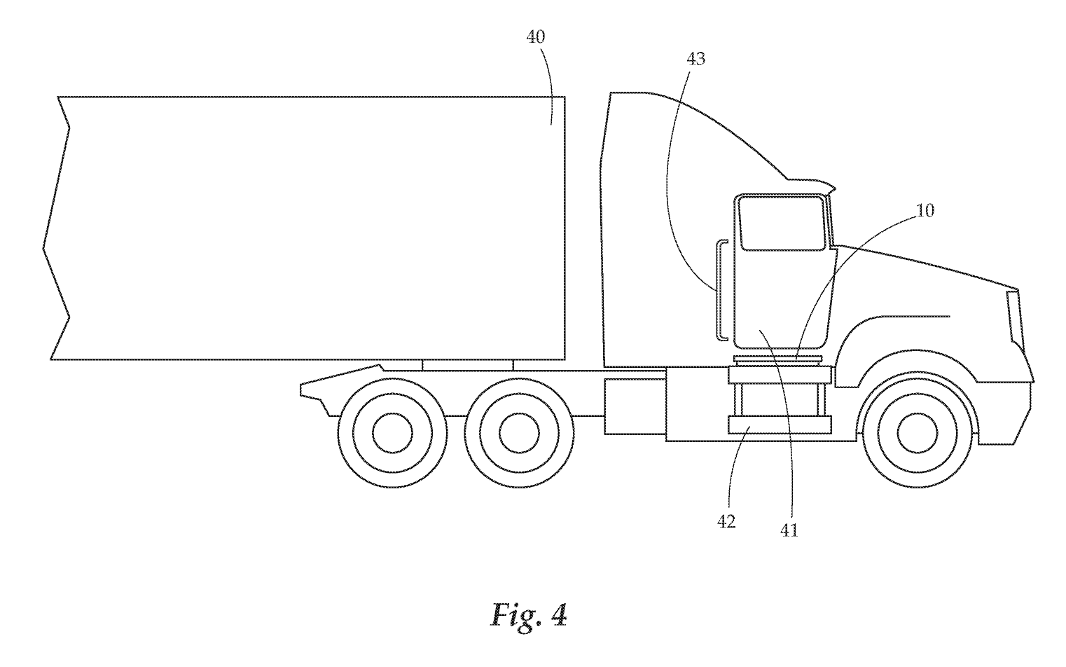

FIG. 4 provides a view of an embodiment of the rotating step installed on a truck. In this view, truck 40 has two steps up into the cab. A first step 42 is a traditional step. Attached to, or built into the second step is the rotating step 10, which is the step closest to the door. A user may open the door 41, step out of the vehicle on to the rotatable step 10, pivot their body without excess strain on their joints, and then be facing outward to exit the vehicle. This operation can be reversed to enter the vehicle. Handle 42 is mounted adjacent to the door 41 which allows a user to hold onto the handle 42 to facilitate pivoting.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A rotatable step for a vehicle comprising:
a base of the rotatable step, the base attachable or integratable into the vehicle adjacent to a vehicle door;
a rotatable platform connected to a top of the base, the platform rotatably connected the base by a bearing;
a rotation of the platform being limited from freely spinning by a friction between the platform and base connection.

2. The rotatable step of claim 1 wherein the bearing is seated in a depression of the top surface of the base.

3. The rotatable step of claim 2 further comprising a ball plate attached to the base, and a plurality of ball bearings on the ball plate, the bearing rotatably seated on top of the plurality of balls.

4. The rotatable step of claim 1 wherein the rotatable platform is rotatable 360 degrees relative to the base about an axis.

5. The rotatable step of claim 1 wherein the rotatable platform is rotatable 90 degrees relative to the base about an axis.

6. The rotatable step of claim 1 wherein the platform is a tread top comprising a tread defined in an upper surface.

7. The rotatable step of claim 6 wherein the tread top platform is rounded, and the tread formed by a plurality of radial recessions and a plurality of concentric circumferential recessions.

8. The rotatable step of claim 1 wherein the base comprises four openings, one of the four openings defined by the base on each of four corners of the base.

9. A vehicle having an elevated door comprising:
a rotatable step adjacent and below the door on a driver's side of the vehicle, the rotatable step comprising:
a base of the rotatable step, the base attached or integrated into the vehicle;
a rotatable platform connected to a top surface of the base, the platform rotatably connected to the base by a bearing;
a rotation of the platform being limited from freely spinning by a friction between the platform and base connection.

10. The vehicle of claim 9 wherein the bearing is seated in a depression of the top surface of the base.

11. The vehicle of claim 10 wherein the depression in the base comprises a bearing track.

12. The vehicle of claim 10 further comprising a ball plate attached to the base, and a plurality of ball bearings on the ball plate, the bearing rotatably seated on top of the plurality of balls.

13. The vehicle of claim 9 further comprising a compression spring applying a pressure between one of the platform and the bearing and the bearing and the base.

14. The vehicle of claim 13 wherein a pressure applied by the compression spring is adjustable by a set screw, a head of the set screw accessible from the rotatable platform.

15. The vehicle of claim 14 wherein the tread top platform is rounded, and the tread formed by a plurality of radial recessions and a plurality of concentric circumferential recessions.

16. The vehicle of claim 9 wherein the base comprises four openings, one of the four openings defined on the base, one opening on each of four corners of the base; and a bolt passing through each of the four openings connecting the base to the vehicle.

17. The vehicle of claim 16 wherein each bolt is secured to an existing step of the vehicle through an aperture in the existing step of the vehicle.

18. The vehicle of claim 9 further comprising a second non-rotating step beneath the rotatable step.

19. The vehicle of claim 9 further comprising a second rotatable step on a passenger side of the vehicle.

20. The vehicle of claim 9 further comprising a handle above the rotatable step adjacent to the door.
